(19) United States
(12) Patent Application Publication
(10) Pub. No.: US 2022/0126145 A1
(43) Pub. Date: Apr. 28, 2022

(54) COLLAPSIBLE AERIAL FIREFIGHTING BUCKETS

(71) Applicant: DONMARK HOLDINGS INC., Delta (CA)

(72) Inventor: Donald Brian ARNEY, Delta (CA)

(21) Appl. No.: 17/509,981

(22) Filed: Oct. 25, 2021

Related U.S. Application Data
(60) Provisional application No. 63/105,110, filed on Oct. 23, 2020.

(51) Int. Cl. A62C 3/02

(52) U.S. Cl. CPC A62C 3/0235

(57) ABSTRACT

An aerial firefighting bucket assembly supported by a harness and includes an open bucket body with a bottom having an opening. A flexible tubular dump valve extends from the opening and has a free end defining a discharge port with a sealing lip defining two opposite lip portions. Pulleys or other roller mechanisms are mounted on one or the other of the lip portions, and end stops are mounted to the opposite lip portion such that each pulley faces an end stop. Flexible support lines from a control mechanism each pass through one pulley and terminate on the corresponding end stop. The lines when tensioned are drawn through the pulley and draw the corresponding end stop towards the pulley to bring the lip portions into sealing contact. The lines when slackened allow the lip portions to be forced apart for dumping water from the bucket.

### BACKGROUND OF THE INVENTION

### Field of the Invention

The invention relates to a collapsible firefighting bucket for being suspended from a helicopter for fighting forest fires, and in particular to a collapsible firefighting bucket having a liquid release valve operated by a plurality of lines connected to the valve.

### Description of Related Art

Firefighting buckets for carrying by helicopter are well known, and typical buckets are disclosed in U.S. Pat. Nos. 4,474,245 and 4,576,237. Improvements to the bucket shown in these patents have been devised over the years, and some of these improvements are shown in U.S. Pat. No. 5,560,429. These patents disclose firefighting buckets made of pliable fabric material having an open upper end with a rim to facilitate filling from an open body of water, a side wall extending downwardly from the rim, and a bottom cooperating with the side wall and having an opening. A tubular extension made of pliable material extends from an opening in the bottom to a free end formed with a discharge port to serve as a dump valve. The discharge port has an array of grommeted openings extending there-around to receive a plurality of cords so that the tubular extension can be drawn upwardly into the bucket by the cords before the bucket is filled with water.

The discharge port has a circumferential sealing lip made of soft and resilient material, which forms two opposite lip portions which are brought into sealing engagement with each other to minimize water leakage from the tubular extension when the dump valve is positioned below the water surface in the bucket. The plurality of cords function as valve control lines, also known as purse lines, and pass through the aligned openings to draw the sealing lips into engagement with each other when the cords are tightened. Tension in the cords supports the tubular extension, and the extension is drawn upwardly through the bucket to be supported in a position which can be below an upper level of water within the bucket. Weight of water acting on the tubular extension tensions the cords and ambient pressure of water acting on the sealing lips augments initial sealing generated by tension in the cords. To dump the water from the bucket, the sleeve is released by rapidly loosening the valve control lines, or purse lines, by a control or trip mechanism, which permits the tubular extension to evert quickly through the opening in the bottom of the bucket. The lip portions are opened under the weight of water, permitting rapid discharge of water with negligible obstruction.

The buckets of the prior art, some of which are described in the patents referenced above, have been very successful and are made in a wide range of sizes, the upper limit of which is dependent upon the carrying capacity of the helicopter. However, a disadvantage shared by them is that the purse lines experience wear as a result of rubbing over the grommets during the deployment and retraction of the dump valve, which over time results in excessive wear and breakages necessitating replacement of the purse lines and down time for the bucket, which could be significant if same occurs during firefighting operations. Accordingly, there is a need for more efficient valve and purse lines mechanism that significantly reduces the wear on the purse lines and significantly increases the life of the purse lines.

### SUMMARY OF THE INVENTION

In order to address some of the shortcomings in the prior art, the present invention provides a collapsible firefighting aerial bucket having a tubular extension as a dump valve that is operated by purse lines connected to sealing lips of the dump valve, wherein the purse lines are routed around pulleys in order to reduce the wear on the purse lines.

In some aspects, the present invention provides an aerial firefighting bucket assembly supported by a harness and includes an open bucket body with a bottom having an opening. A flexible tubular dump valve extends from the opening and has a free end defining a discharge port with a sealing lip defining two opposite lip portions. Pulleys or other roller mechanisms are mounted on one or the other of the lip portions, and end stops are mounted to the opposite lip portion such that each pulley faces an end stop. Flexible support lines from a control mechanism each pass through one pulley and terminate on the corresponding end stop. The lines when tensioned are drawn through the pulley and draw the corresponding end stop towards the pulley to bring the lip portions into sealing contact. The lines when slackened allow the lip portions to be forced apart for dumping water from the bucket.

In some aspects, the present invention provides a collapsible firefighting bucket assembly to be suspended from an aircraft comprising: an open bucket body of pliable material having an open upper rim to facilitate filling from an open body of water, a side wall extending downwardly from the rim and a bottom cooperating with the side wall and having an opening; a dump valve comprising of a tubular extension made of pliable material and extending from the opening in the bottom, the tubular extension having a free end with a discharge port, the discharge port having a sealing lip that defines two opposite lip portions that are brought into sealing contact with each other for minimizing water leakage from the tubular extension; a plurality of roller mechanisms connected to the sealing lip adjacent one or another of the lip portions; a plurality of end stops connected to the sealing lip such that each end stop is on an opposite lip portion to a corresponding roller mechanism; a plurality of flexible support lines connected at one end to a control mechanism and each support line passing through one roller mechanism and having a terminal end connected to the corresponding end stop on the opposite lip portion; a harness for suspending the bucket from the aircraft; and the lines when tensioned cooperate with the roller mechanism and the end stops to bring the lip portions into sealing contact and to hold the tubular extension in a raised position in which the free end thereof extends upwardly from the bottom with the discharge port positioned below a full water level in the bucket, the control mechanism being operable to slacken the lines to allow the tubular extension to extend downwardly from the bottom of the bucket for dumping the water.

In some embodiments of the firefighting bucket assembly, the roller mechanism may comprise multiple rollers arranged in a configuration to at least partially surround the line passing through the roller mechanism.

In some embodiments of the firefighting bucket assembly, at least some of the roller mechanisms may be pivotably connected to the sealing lips to enable each of the at least some roller mechanisms to pivot or swivel relative to the sealing lip.

In some aspects, the present invention provides a collapsible firefighting bucket assembly to be suspended from an aircraft comprising: an open bucket body of pliable material having an open upper rim to facilitate filling from an open body of water, a side wall extending downwardly from the rim and a bottom cooperating with the side wall and having an opening; a dump valve comprising of a tubular extension made of pliable material and extending from the opening in the bottom, the tubular extension having a free end with a discharge port, the discharge port having a sealing lip that defines two opposite lip portions that are brought into sealing contact with each other for minimizing water leakage from the tubular extension; a plurality of pulleys connected to the sealing lip adjacent one or another of the lip portions; a plurality of end stops connected to the sealing lip such that each end stop is on an opposite lip portion to a corresponding pulleys; a plurality of flexible support lines connected at one end to a control mechanism and each support line passing through one pulleys and having a terminal end connected to the corresponding end stop on the opposite lip portion; a harness for suspending the bucket from the aircraft; and the lines when tensioned cooperate with the pulleys and the end stops to bring the lip portions into sealing contact and to hold the tubular extension in a raised position in which the free end thereof extends upwardly from the bottom with the discharge port positioned below a full water level in the bucket, the control mechanism being operable to slacken the lines to allow the tubular extension to extend downwardly from the bottom of the bucket for dumping the water.

In some embodiments of the firefighting bucket assembly, at least some pulleys are pivotably connected to the sealing lips to enable each of the at least some pulleys to pivot or swivel relative to the sealing lip. In some embodiments, all pulleys are pivotably connected to the sealing lips to enable each of the at least some pulleys to pivot or swivel relative to the sealing lip.

In some embodiments of the firefighting bucket assembly, the end stops may each comprise a tab extending beyond the sealing lip to which is connected the terminal end of the line passing through the corresponding roller mechanism.

In some embodiments of the firefighting bucket assembly, the tab may include an opening through which the line passes and the terminal end includes a releasable enlarged stop that prevents the terminal end from being withdrawn from the opening thereby connecting the line to the tab.

In some embodiments of the firefighting bucket assembly, the tab may be flexible and may include a rigid insert circumscribing the opening to provide rigidity to a portion of the tab about the opening.

In some embodiments of the firefighting bucket assembly, the enlarged end stop may comprise a knot provided in the terminal end of the line.

In some aspects the present invention provides a flexible dump valve mountable to a bottom of a firefighting helicopter bucket of the kind controlled by a plurality of flexible control lines connected at an end to a control mechanism and each line having a terminal end, the dump valve comprising: a tubular extension made of pliable material and being mountable at an end to the bottom of the bucket, the tubular extension having a free end with a discharge port, the discharge port having a sealing lip that defines two opposite lip portions that are brought into sealing engagement with each other for minimizing water leakage from the tubular extension; a plurality of roller mechanisms connected to the sealing lip adjacent one or another of the lip portions; a plurality of end stops connected to the sealing lip such that each end stop is on an opposite lip portion to a corresponding roller mechanism; wherein each roller mechanism is operable to receive one of the control lines and each end stop is operable to connect to the terminal end of the line passing through the corresponding roller mechanism.

In some embodiments of the flexible dump valve, the roller mechanism comprises multiple rollers arranged in a configuration to at least partially surround the line passing through the roller mechanism.

In some embodiments of the flexible dump valve, at least some of the roller mechanisms are pivotably connected to the sealing lips to enable each of the at least some roller mechanisms to pivot or swivel relative to the sealing lip.

In some embodiments of the flexible dump valve, the roller mechanisms comprise pulleys.

In some embodiments of the flexible dump valve, at least some pulleys are pivotably connected to the sealing lips to enable each of the at least some pulleys to pivot or swivel relative to the sealing lip.

In some embodiments of the flexible dump valve, the end stops each comprise a tab extending beyond the sealing lip to which is connected the terminal end of the line passing through the corresponding roller mechanism.

In some embodiments of the flexible dump valve, the tab includes an opening through which the line passes and the terminal end includes a releasable enlarged stop that prevents the terminal end from being withdrawn from the opening thereby connecting the line to the tab.

In some embodiments of the flexible dump valve, the tab is flexible and includes a rigid insert circumscribing the opening to provide rigidity to a portion of the tab about the opening.

In some embodiments of the flexible dump valve, the enlarged end stop comprises a knot provided in the terminal end of the line.

### BRIEF DESCRIPTION OF THE DRAWINGS

Further features and advantages will be apparent from the following detailed description, given by way of example, of preferred embodiments taken in conjunction with the accompanying drawings, wherein:

FIG. 1 is a perspective view of a collapsible firefighting aerial bucket in accordance with the prior art;

FIG. 2 is a close-up section of the tubular extension or dump valve of the collapsible firefighting aerial bucket of FIG. 1;

FIG. 3 is a perspective view of a collapsible firefighting aerial bucket in accordance with an embodiment of the present invention;

FIG. 4 is a close-up perspective view of the tubular extension or dump valve of the embodiment of FIG. 3;

FIG. 5 is a close-up perspective view of the tubular extension or dump valve of the embodiment of FIG. 3 shown partially submerged in water;

FIG. 6 is a close-up section view of a portion of the tubular extension or dump valve of the embodiment of FIG. 3;

FIG. 7 is a close-up section view of the portion of the tubular extension or dump valve of FIG. 3 shown from another side; and

FIGS. 8 and 9 are schematic views of other embodiments of a roller mechanism that receives the purse line, which is represented in cross section by a solid circle.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention as defined by the claims.

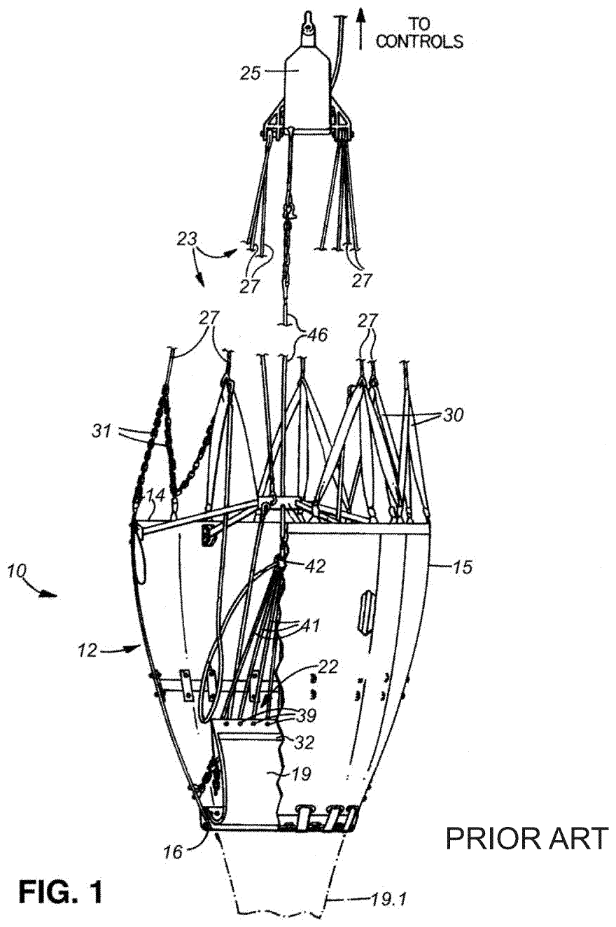

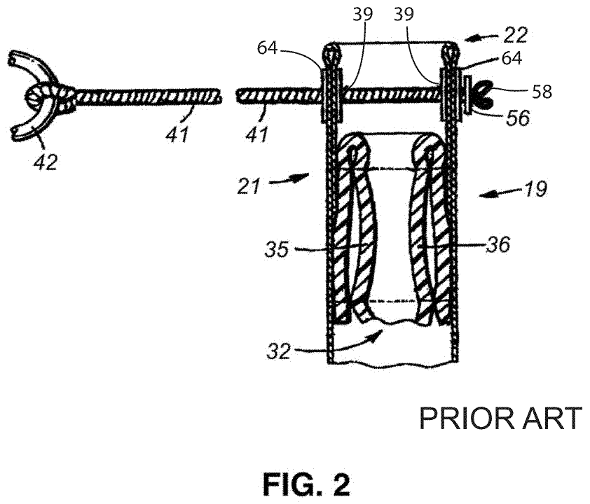

Referring to FIGS. 1-2, there is shown an embodiment of a prior art collapsible firefighting bucket 10 that is further described herein for context. Prior art firefighting bucket 10 has an open bucket body 12 made of a tough pliable material, for example a vinyl impregnated woven synthetic fabric, and has an open upper rim 14 to facilitate filling from an open body of water, i.e. by dipping into the water. The body has a side wall 15 extending downwardly from the rim and a bottom 16 cooperating with the side wall and defining an opening. A tubular extension 19 made of pliable material is shown in a retracted position extending upwardly into the bucket from the opening in the bottom and has a free end portion formed with a discharge port 22 to serve as a dump valve. In FIG. 1, the tubular extension is shown fragmented in full outline in the retracted or raised position and is also partially shown in broken outline in an extended or lowered position 19.1 downwardly from the bucket with the dump valve opened to permit discharge of water from the bucket.

The prior art collapsible firefighting bucket 10 typically includes a harness 23 for suspending the bucket from an aircraft (not shown), the harness comprising a control mechanism such as control head 25 which also serves as a connector for connecting to the aircraft, and a plurality of flexible tension links 27 e.g. support cables, connected to the connector 25. The control head functions to retract and extend the purse lines 41 to allow for the release and retraction respectively of the dump valve 19. The harness 23 also includes a plurality of support cables or flexible fabric straps 30 disposed in a zig-zag fashion around and extending upwardly from the upper rim 14 to connect with the plurality of cables or flexible tension links 27. One portion of the rim has a plurality of link chains 31, similarly connected in a zig-zag fashion to the rim as the straps 30, to weight one side of the bucket to unbalance the bucket so as to facilitate filling as the bucket is dipped in a body of water, as well as to resist abrasion when the bucket is scoop filled in debris laden water.

The discharge port 22 has a sealing lip 32 that extends circumferentially around the inside of the tubular extension and defines two opposite sealing lip portions 35 and 36 (FIG. 2 only) that are brought into sealing engagement with each other for minimizing water leakage from the tubular extension. The tubular extension has a plurality of openings 39, which cooperate with a plurality of tension lines such as purse lines 41 extending downwardly from a releasable connector such as connector clip 42. The connector clip 42 is connected to a trip line 46, which is connected to the control head 25. Accordingly, the releasable connector is connected to the control mechanism. The control head is operable to rapidly slacken the reel line and the trip line when the bucket is loaded with water so as to discharge the load, and to retract the reel line to enable the return of the tubular extension to the raised position that usually occurs while the bucket is dipped in a body of water during filling while there is no tension on the purse lines as a result. Operation of the dump valve is described in detail in the above-referenced U.S. patents.

The purse lines of the prior art are typically identical in composition, and a typical purse line is described as follows. Each purse line 41 passes through a pair of aligned openings 39 in the grommets 64 which are but adjacent the two opposite lip portions 35 and 36 as shown. Thus, each opening is associated with a respective lip portion. The typical prior art purse line has an outer end on which is tied a knot or other end stop 58 that prevents the outer end from passing through the grommet and an inner end that is tied to a riser ring, which in turn is supported by the trip line 46. The end knot is typically a figure-of-eight knot tied adjacent the end of the line with a washer 56 fitted between the grommet 64 and the knot. The inner end of the purse line is secured to the ring with a suitable knot, usually provided with several half-hitches to prevent inadvertent undoing of the knot. The length of the purse lines is individually and manually adjusted to ensure that, when the valve is withdrawn into the bucket, the sealing lip portions 35 and 36 are drawn tightly and evenly into engagement with each other, with oppositely facing terminal edges being generally coplanar with each other. As is apparent, the purse lines slide through the grommets 64 and over time the friction generated results in wear in the purse lines. Worn or broken purse lines must be replaced.

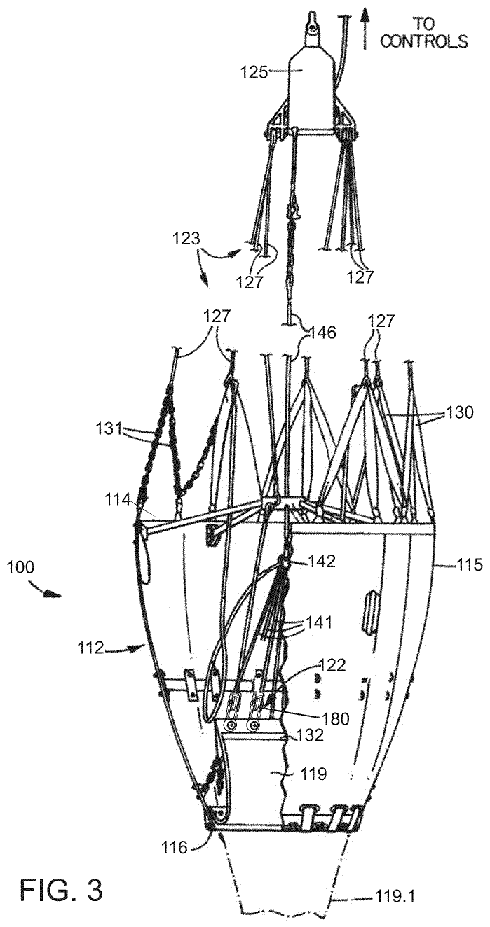

Referring to FIGS. 3-7, a firefighting bucket 100 according to the invention bears many similarities to the earlier firefighting buckets as disclosed in the aforementioned U.S. patents. The improvements over the prior art firefighting buckets comprise the structures of the lip of the dump valve through which the purse lines pass.

Accordingly, firefighting bucket 100 has an open bucket body 112 made of a tough pliable material, for example a vinyl impregnated woven synthetic fabric, and has an open upper rim 114 to facilitate filling from an open body of water, i.e. by dipping into the water. The body has a side wall 115 extending downwardly from the rim and a bottom 116 cooperating with the side wall and defining an opening.

A tubular extension 119 (also referred to herein as a dump valve) made of pliable material is shown in a retracted position extending upwardly into the bucket from the opening in the bottom and has a free end portion 121 formed with a discharge port 122 to serve as a dump valve. In FIG. 3, the tubular extension is shown fragmented in full outline in the retracted or raised position and is also partially shown in broken outline in an extended or lowered position 119.1 downwardly from the bucket with the dump valve opened to permit discharge of water from the bucket.

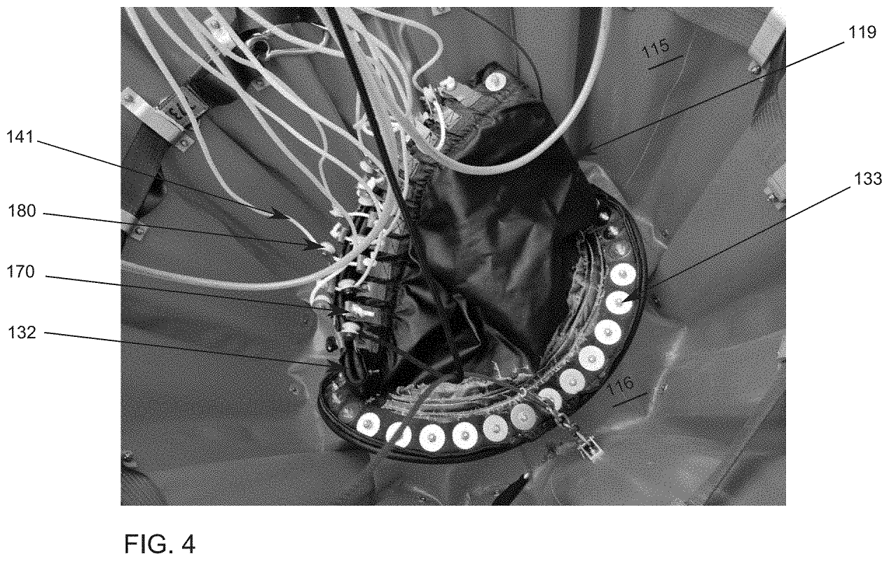

The tubular extension 119 is preferably removably connected to the bottom 116 of the bucket 100 by removable fasteners such as nut and bolt combinations 133 arranged around the perimeter of the tubular extension 119, as shown in FIG. 4.

The collapsible firefighting bucket 110 may also include a harness 123 for suspending the bucket from an aircraft (not shown), the harness comprising a control mechanism such as control head 125 which also serves as a connector for connecting to the aircraft, and a plurality of flexible tension links 127 e.g., support cables, connected to the connector 125. The control head functions to retract and extend the purse lines 141 to allow for the release and retraction respectively of the dump valve 119. The harness 123 may also include a plurality of support cables such as flexible fabric straps 130 disposed around and extending upwardly from the upper rim 114 to connect with the plurality of cables or flexible tension links 127.

The discharge port 122 of the tubular extension 119 has a sealing lip 132 that extends circumferentially around the inside of the tubular extension 119 and defines two opposite sealing lip portions 135 and 136 (FIGS. 4-7) that are brought into sealing engagement with each other for minimizing water leakage from the tubular extension. The tubular extension 119 is connected to a plurality of tension lines such as purse lines 141 extending downwardly from a releasable connector such as connector clip 142. The connector clip 142 may be connected to a trip line 146, which may be connected to the control head 125. The control head is operable to rapidly slacken the reel line and the trip line when the bucket is loaded with water so as to discharge the load, and to retract the reel line to enable the return of the tubular extension to the raised position that usually occurs while the bucket is dipped in a body of water during filling while there is no tension on the purse lines as a result.

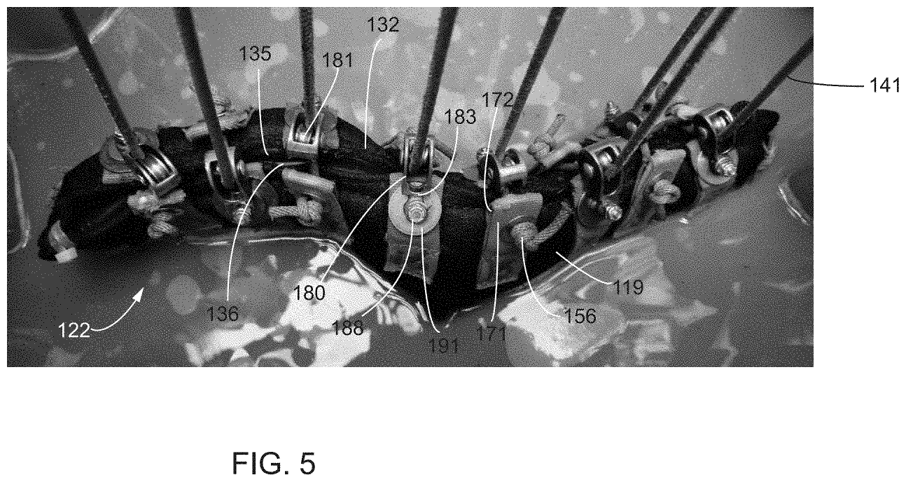

On the outside surface of the tubular extension 119 adjacent the sealing lip 132 are spaced a plurality of roller mechanisms such as purse line pulleys 180 through which the purse lines pass, and a plurality of purse line end stops 170 to which the terminal end of the purse lines 141 are affixed. The pulleys 180 and the end stops 170 are positioned around the perimeter of the outside surface of the tubular extension 119 in such a manner that each pulley 180 is opposite an end stop 170 when the sealing lip portions 135 and 136 are in contact and the sealing lip 123 is closed. As illustrated, the pulleys 180 and end stops 170 may alternate along each sealing lip portion 135 and 136, as best shown in FIG. 5, such that there are equal numbers of pulley 180 and end stops 170 on each side.

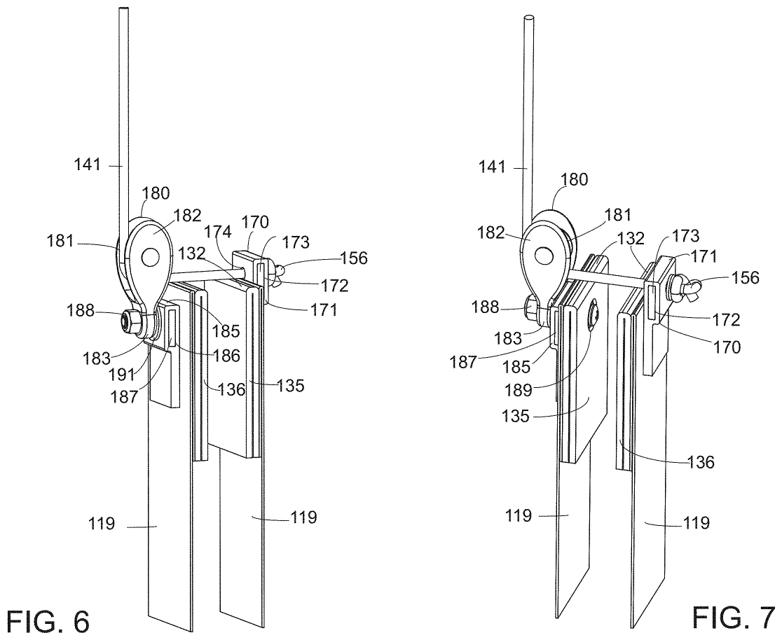

In the illustrated embodiment, each end stop 170 comprises flexible tab 171 that defines a pocket 172 in which a rigid insert 173 is provided. The tab 171 is positioned on outside surface of the tubular extension 119 in a manner that the pocket 172 and the rigid insert 173 extend beyond the sealing lip 132, as shown in FIGS. 6 and 7. A hole 174 is provided passing through the tab 170 and the insert 173. The end of the purse line 141 threads through the hole 174 and a releasable end stop such as knot 156 on the terminal end secures the purse line to the tab 170 by preventing the purse line from being withdrawn from the tab 170. The rigid insert 173 provides structural support for the end of the purse line 141, and may be made of rigid plastic, metal or other suitably rigid material. The tab 171 may be made of a durable flexible material such as webbing. In some embodiments, the rigid insert 173 may be a washer positioned to circumscribe the hole to provide a requisite rigidity.

While the illustrated end stop 170 is one embodiment of an end stop, other structures for the end stops will be apparent to the skilled reader in which the end of the purse line is secured to a tab that extends beyond the sealing lip 132. For example, without limitation, the end stop 170 may be unitary and rigid, or the tab 171 may be unitary and rigid but flexibly connected to the tubular extension. As well, the terminal end of the purse line may be affixed to the end stop in some other suitable manner or mechanism than with knot 156 as illustrated.

Each purse line pulley 180 is connected to the outer surface of the tubular extension 119 in a manner that the wheel 181 of the pulley 180 extends beyond the sealing lip 132 to provide clearance for the purse line 141 from the sealing lip 132 as it passes over the wheel 181 and terminates in the corresponding opposite end stop 170 on the other sealing lip portion. In operation, as the purse lines 141 are retracted by the operation of the control head, each acts against its corresponding pulley 180 and end stop 170 to draw the sealing lip portions 135 and 136 together. When the purse lines 141 are allowed to extend by the control head 125, the slackness in the purse lines 141 allow the weight of water in the bucket 100 to force the sealing lip portions 135 and 136 apart to allow water to be dumped from the bucket. The pulleys 180 provide a low friction mechanism by which the purse lines 141 can travel relative to the lip portions and thereby minimize the wear on the purse lines.

Preferably, each pulley 180 is pivotably connected to the outer surface of the tubular extension 119 to enable some side to side pivoting or swiveling of the pulley 180. This advantageously accommodates for the varying angles at which the purse lines 141 engage the pulleys during retraction or extension of the purse lines. If the pulleys are fixedly connected to the outer surface of the tubular extension 119, then misaligned purse lines may rub against the pulley blocks 182 for part of the travel during each cycle and thereby increasing the wear on the purse lines. In the illustrated embodiment, the swiveling movement is accomplished by not fully tightening the nut of the nut and bolt combination 188; the nut should be snug but not tight as that would stop the pulley from swiveling. It would thus be apparent to the person skilled in the art that an alternate mechanism could be used to the nut and bolt combination to secure the pulley to the lip yet provide sufficient free play for the pulley to swivel. Preferably, the pulleys 180 omit the cross members on each one's block that are shown on the version of pulleys illustrated in FIG. 5, so that the pulley blocks are open like those of pulleys 180 shown in FIGS. 4, 6 and 7 in order to reduce the risk of abrasion to the purse lines 141 from rubbing against such cross members.

Referring to FIGS. 6 and 7, in the illustrated embodiment each pulley 180 is connected to the sealing lip portion 135 or 136 of the tubular extension 119 by means of second flexible tab 185 having a pocket 186 in which is provided a rigid insert 187, and the support portion 183 of the block 182 is secured to the tab 185 by a fastener such as nut and bolt combination 188 that passes through the support portion 183, a hole 189 provided through the tab 185, rigid insert 187 and the sealing lip portion 135 or 136 (depending on which side the pulley is located). In order to facilitate the pivoting or swiveling of the pulley 180, a low friction rigid washer 191 is provided between the support portion 183 and the tab 185.

Accordingly, the positioning of the end stop 170 and the pulley 180 relative to the sealing lip 132 enables the purse line 141 to span between the end stop and the pulley 180 clear of the sealing lip portions 135 and 136. As the purse line 141 is retracted, it passes over the pulley 180 and draws the end stop 170 and the pulley 180 and the sealing lip portions 135 and 136 towards each other thereby sealing the tubular extension 119 and drawing the tubular extension into the body of the bucket. As a purse line 141 is extended, the slack in the line allows the pulley 180 and the end stop 172 be forced apart as a result of the weight of water in the bucket tending to push the tubular extension 119 outward and the ceiling portions 135 and 136 apart.

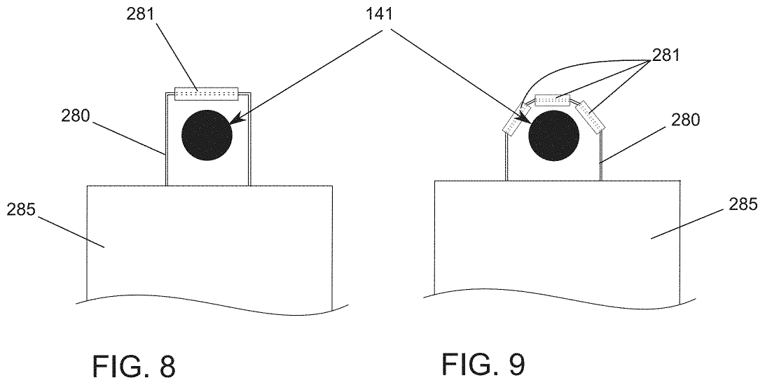

With reference to FIGS. 8 and 9, there are schematically illustrated other embodiments of a roller mechanism 280 to receive the purse lines 141 and mounted to a tab 285 that is itself mounted to a lip portion. In FIG. 8, roller mechanism 280 comprises a roller 281 on which the line rolls, having an analogous function to the wheel 181 of pulley 180 in the embodiments described above. In FIG. 9, roller mechanism 280 comprises multiple rollers 281 arranged in a configuration to at least partially surround the line 141 passing through the roller mechanism to reduce the chance of the line binding.

While specific embodiments of the invention have been described, such embodiments are illustrative of the invention only and should not be taken as limiting its scope. In light of the present disclosure, many modifications will occur to those skilled in the art to which the invention relates, and the invention, therefore, should be construed in accordance with the accompanying claims.

What is claimed:

1. A firefighting bucket assembly to be suspended from an aircraft comprising:
an open bucket body having an open upper rim to facilitate filling from an open body of water, a side wall extending downwardly from the rim and a bottom cooperating with the side wall and having an opening;
a dump valve comprising of a tubular extension made of pliable material and extending from the opening in the bottom, the tubular extension having a free end with a discharge port, the discharge port having a sealing lip that defines two opposite lip portions that are brought into sealing contact with each other for minimizing water leakage from the tubular extension;
a plurality of roller mechanisms connected to the sealing lip adjacent one or another of the lip portions;
a plurality of end stops connected to the sealing lip such that each end stop is on an opposite lip portion to a corresponding roller mechanism;
a plurality of flexible support lines connected at one end to a control mechanism and each support line passing through one roller mechanism and having a terminal end connected to the corresponding end stop on the opposite lip portion;
a harness for suspending the bucket from the aircraft; and
the lines when tensioned cooperate with the roller mechanism and the end stops to bring the lip portions into sealing contact and to hold the tubular extension in a raised position in which the free end thereof extends upwardly from the bottom with the discharge port positioned below a full water level in the bucket, the control mechanism being operable to slacken the lines to allow the tubular extension to extend downwardly from the bottom of the bucket for dumping the water.

2. The apparatus of claim 1 wherein the roller mechanism comprises multiple rollers arranged in a configuration to at least partially surround the line passing through the roller mechanism.

3. The apparatus of claim 1 wherein at least some of the roller mechanisms are pivotably connected to the sealing lips to enable each of the at least some roller mechanisms to pivot or swivel relative to the sealing lip.

4. The apparatus of claim 1 wherein the roller mechanisms comprise pulleys.

5. The apparatus of claim 4 wherein at least some pulleys are pivotably connected to the sealing lips to enable each of the at least some pulleys to pivot or swivel relative to the sealing lip.

6. The apparatus of any one of claims 1-5 wherein the end stops each comprises a tab extending beyond the sealing lip to which is connected the terminal end of the line passing through the corresponding roller mechanism.

7. The apparatus of claim 6 wherein the tab includes an opening through which the line passes and the terminal end includes a releasable enlarged stop that prevents the terminal end from being withdrawn from the opening thereby connecting the line to the tab.

8. The apparatus of claim 7 wherein the tab is flexible and includes a rigid insert circumscribing the opening to provide rigidity to a portion of the tab about the opening.

9. The apparatus of claim 8 wherein the enlarged end stop comprises a knot provided in the terminal end of the line.

10. A flexible dump valve mountable to a bottom of a firefighting helicopter bucket of the kind controlled by a plurality of flexible control lines connected at an end to a control mechanism and each line having a terminal end, the dump valve comprising:
a tubular extension made of pliable material and being mountable at an end to the bottom of the bucket, the tubular extension having a free end with a discharge port, the discharge port having a sealing lip that defines two opposite lip portions that are brought into sealing engagement with each other for minimizing water leakage from the tubular extension;
a plurality of roller mechanisms connected to the sealing lip adjacent one or another of the lip portions;
a plurality of end stops connected to the sealing lip such that each end stop is on an opposite lip portion to a corresponding roller mechanism;
wherein each roller mechanism is operable to receive one of the control lines and each end stop is operable to connect to the terminal end of the line passing through the corresponding roller mechanism.

11. The apparatus of claim 10 wherein the roller mechanism comprises multiple rollers arranged in a configuration to at least partially surround the line passing through the roller mechanism.

12. The apparatus of claim 10 wherein at least some of the roller mechanisms are pivotably connected to the sealing lips to enable each of the at least some roller mechanisms to pivot or swivel relative to the sealing lip.

13. The apparatus of claim 10 wherein the roller mechanisms comprise pulleys.

14. The apparatus of claim 13 wherein at least some pulleys are pivotably connected to the sealing lips to enable each of the at least some pulleys to pivot or swivel relative to the sealing lip.

15. The apparatus of claim 10 wherein the end stops each comprise a tab extending beyond the sealing lip to which is connected the terminal end of the line passing through the corresponding roller mechanism.

16. The apparatus of claim 15 wherein the tab includes an opening through which the line passes and the terminal end includes a releasable enlarged stop that prevents the terminal end from being withdrawn from the opening thereby connecting the line to the tab.

17. The apparatus of claim 16 wherein the tab is flexible and includes a rigid insert circumscribing the opening to provide rigidity to a portion of the tab about the opening.

18. The apparatus of claim 17 wherein the enlarged end stop comprises a knot provided in the terminal end of the line.
